(19) United States
(12) Patent Application Publication
(10) Pub. No.: US 2026/0019938 A1
(43) Pub. Date: Jan. 15, 2026

(54) COORDINATED CONTROL OF A RADIO ACCESS NETWORK FOR LINK RELIABILITY AND METHODS FOR USE THEREWITH

(71) Applicant: ISRD Sp. z o.o., Piaseczno (PL)

(72) Inventors: Farinaz Kooshki, Piaseczno (PL); Robert Gdowski, Warsaw (PL); Slawomir Pietrzyk, Piaseczno (PL)

(73) Assignee: ISRD Sp. z o.o., Piaseczno (PL)

(21) Appl. No.: 19/257,957

(22) Filed: Jul. 2, 2025

Related U.S. Application Data
(60) Provisional application No. 63/668,930, filed on Jul. 9, 2024.

(51) Int. Cl. H04W 48/20; H04W 24/08; H04W 76/15

(52) U.S. Cl. CPC H04W 48/20; H04W 24/08; H04W 76/15

(57) ABSTRACT

A network general controller for use with a radio access network (RAN) operates by: determining RAN conditions associated with the RAN, the RAN having a plurality of radio units (RUs), distributed units (DUs) and centralized units (CUs) that facilitate communication with user equipment (UEs) via a plurality of resource block sets (RBS); determining a plurality of UE performance metrics corresponding to the UEs; generating, based on the RAN conditions and based on the performance metrics corresponding to the UEs, selections of a plurality of RAN-Sets (RANS) from the plurality of RUs, DUs and CUs and a UE-RBS-RANS allocation that configures the communication with the UEs via redundant links based on the selections of the RANS and based on a multiplexed sequence of RBS of the plurality of RBS; and facilitating communication with the UEs in accordance with the UE-RBS-RANS allocation.

### CROSS-REFERENCE TO RELATED APPLICATIONS

The present U.S. Utility patent application claims priority pursuant to 35 U.S.C. § 119 (e) to U.S. Provisional Application No. 63/668,930, entitled “COORDINATED CONTROL OF A RADIO ACCESS NETWORK FOR LINK RELIABILITY AND METHODS FOR USE THEREWITH”, filed Jul. 9, 2024, which is hereby incorporated herein by reference in its entirety and made part of the present U.S. Utility patent application for all purposes.

### FIELD OF THE DISCLOSURE

The subject disclosure relates to implementation and control of wireless communication networks.

### BRIEF DESCRIPTION OF THE DRAWINGS

Reference will now be made to the accompanying drawings, which are not necessarily drawn to scale, and wherein:

FIG. 1A is a schematic/block diagram illustrating a non-limiting example of a communications network in accordance with various aspects described herein.

FIG. 1B is a flow diagram illustrating a non-limiting example of a method in accordance with various aspects described herein.

FIG. 2 is a schematic/block diagram illustrating a non-limiting example of a network general controller in accordance with various aspects described herein.

FIG. 3A is a schematic/block diagram illustrating a non-limiting example of RAN-Sets and RB-Sets in accordance with various aspects described herein.

FIGS. 3B, 3C, 3D and 3E are schematic/block diagrams illustrating non-limiting examples of use cases in accordance with various aspects described herein.

FIGS. 4A and 4B are schematic/block diagrams illustrating non-limiting examples of UE-RBS-RANS allocations in accordance with various aspects described herein.

### DETAILED DESCRIPTION

One or more examples/embodiments are now described with reference to the drawings, wherein like reference numerals are used to refer to like elements throughout. In the following description, for purposes of explanation, numerous details are set forth in order to provide a thorough understanding of the various examples. It is evident, however, that the various examples can be practiced without these details (and without applying to any particular networking environment or standard).

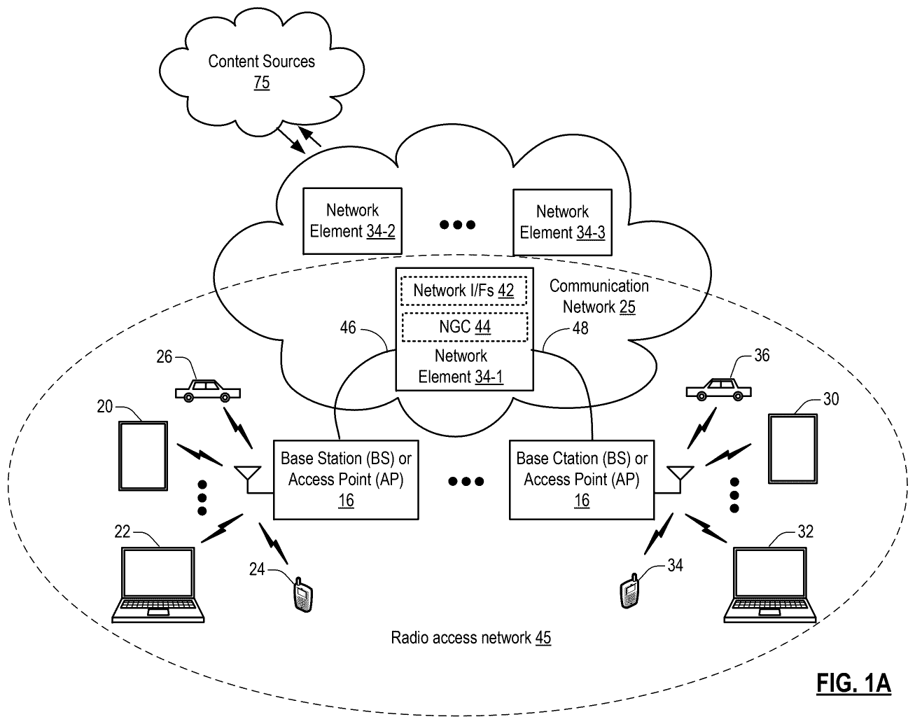

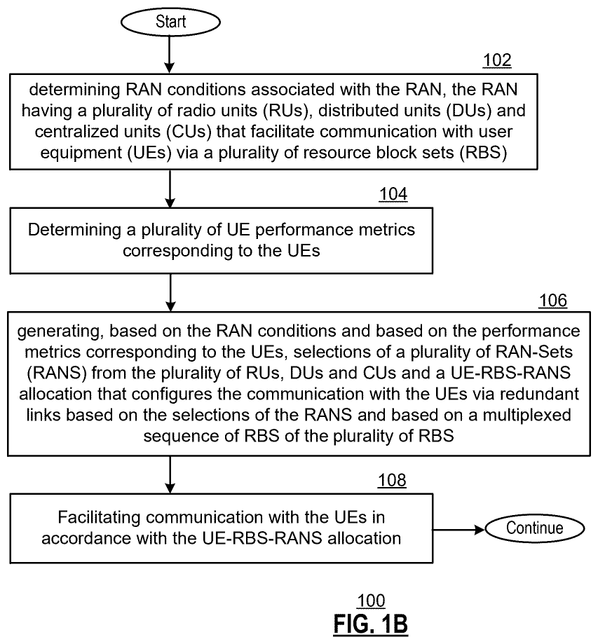

Referring now to FIG. 1, a schematic/block diagram is shown illustrating an example, non-limiting example of a communications network 125, such as a core communications network or other wide area network in accordance with various aspects described herein. In particular, the communications network 125 includes a plurality of network elements 34, such as network elements 34-1, 34-2 and 34-3 that are shown.

In various examples, the network elements 34 are interconnected via transport links that can be wired, optical and/or wireless links that, for example, support encapsulated and encrypted transport. The network elements 34 can be implemented, for example, with the use of radio access network (RAN) controllers, RAN intelligent controllers (RIC) either non-real time, near real time or real time, programmable switches, edge servers, soft switches, network gateways, media distribution hubs, other routers, edge devices, switches or network nodes and/or other network functions/devices and combinations thereof that themselves can be implemented via special purpose hardware, and/or via general purpose hardware computing programmed to perform their respective functions.

The communications network 125 operates to support communications including communications via the radio access network (RAN) 45. In operation, the communication network 125 transports data received from content sources 175 or other data content transport clients, and/or data conveying other communications between wireless communication devices. This data can include, e.g., audio, video, graphics, text or other media, applications control information, billing information, network management information and/or other data. The core communication network 125 (or more simply the core) also operates to manage access by the wireless communication devices, provides billing and network management and supports other network functions.

The wireless communication devices include tablets 20 and 30, laptops 22 and 32, mobile phones 24 and 34, vehicles 26 and 36 and/or other fixed or mobile communication devices. The wireless communications can include signals formatted in accordance with 3GPP, long term evolution (LTE) 4G, 5G, other orthogonal frequency division multiple access (OFDMA) protocols and/or other wireless signaling. These wireless communications devices can be referred to as client devices or user equipment (UEs), regardless of the particular standard used to communicate with these particular devices.

The wireless communication devices communicate with base station or access points 16 to receive services from the communication network 125. Typically, base stations are used for cellular telephone systems and like-type systems, while access points are typically used for in-home or in-building wireless networks. For direct connections (i.e., point-to-point communications), wireless communication devices communicate directly with the BS or AP 16 via an allocated channel, time slot, uplink/downlink (UL/DL) configurations and/or other physical resource block (“PRB” or more simply “RB”) of a radio channel serviced by a plurality of radio units (RUs) that operate in conjunction with baseband processing to convert communications from the communications network 125 into wireless communications of the radio access network 45 and vice versa. Regardless of the particular type of communication system, each wireless communication device also includes, or is coupled to, a corresponding radio configured for wireless communications via the radio access network 45.

In the example shown, the network element 34-1 includes an edge server, radio access network general controller and/or other network element or elements having a plurality of network interfaces (I/Fs) 42. The plurality of network interfaces (I/Fs) 42 can include a wide area network interface for operating over one or more backhaul links with other network elements 34 operating to support data transport. In addition, the network interfaces (I/Fs) 42 can support communications with other network elements 34 operating other portions of the radio access network 45. The plurality of network interfaces 42 can further support a plurality of other links 46 and 48, for upstream and downstream communication with a plurality of wireless communications devices over the radio access network 45 via base station (BS) or access points (AP) 16. For example, the network interfaces 42 can include a core network interface configured to communicate network communications with one or more network elements 34 of a core communication network, and a radio network interface configured to communicate communications BS or APs 16 of the radio access network 45. These interfaces 42 can operate via F1, E2, evolved packet core (EPC), next generation core (NGC), 5G core or via another network protocol or standard. The network element 34-1 can also include a cooperative radio resource manager or other radio resource manager that operates to support resource management of the radio access network 45 including load control and power control, and/or admission control, packet scheduling, hand-over control, and/or other user plane and control plane functions of a radio network controller/radio access network intelligent controller, etc.

In addition or in the alternative, the network element 34-1 and BS or AP 16 of the can be implemented in conjunction radio transceivers and baseband processing units in accordance with one or more deployment models e.g., Open RAN, disaggregated RAN, virtualized RAN, etc. and/or other standard that is based on interoperability and standardization of RAN elements and can include an interconnection standard for white-box hardware and open source software elements from different vendors to provide an architecture that integrates a modular base station software stack on off-the-shelf hardware which allows baseband and radio unit components from discrete suppliers to operate seamlessly together. In various examples, the network element 34-1 can include a packet processing function (PPF) which contains user-plane functions that are asynchronous to the Hybrid Automatic Repeat Request (HARQ) loop, and includes the Packet Data Convergence Protocol (PDCP) layer—such as encryption—and the multipath handling function for the dual connectivity anchor point and data scheduling and/or a radio control function (RCF) that handles load sharing among system areas and different radio technologies, as well as the use of policies to control the schedulers in the RPFs and PPFs. At the user and bearer level, the RCF can, for example, operate to negotiate QoS and other policies with other domains and is responsible for the associated service level agreement (SLA) enforcement in the RAN and/or to control the overall RAN performance relative to the service requirement, creates and manages analytics data, and the RAN self-organizing network (SON) functions. An efficient and effective scheduler for implementing a network-wide cooperative approach to radio resource management (RRM) is provided in U.S. Pat. No. 11,889,494 entitled, “COOPERATIVE RADIO RESOURCE SCHEDULING IN A WIRELESS COMMUNICATION NETWORK AND METHODS FOR USE THEREWITH”.

While the BS or APs 16 are shown schematically as if having a single antenna, the BS or APs 16 (which can also be referred to as eNodeBs, eNBs, gNodeBs, gNBs, etc.) can each include a plurality of RUs (each with one or more antennas) that are supported by baseband processing via a combination of distributed units (DUs) and centralized units (CUs). In various examples, CUs, DUs and RUs communicate control plane and user plane signaling from the UEs to the core network. The CUs/DUs/RUs operate in conjunction with a radio access network protocol stack (that can be called more simply a “RAN stack” or “radio stack”) that can include, for example, a physical (PHY) layer, media access control (MAC) layer, radio link control (RLC) layer and one or more upper layers such as a Packet Data Convergence Protocol (PDCP) layer and/or a service data adaptation protocol (SDAP) layer, and/or other layers, etc. that also can be referred to as RAN stack components.

The network element 34-1 and BS or AP 16 can cooperate and operate in an architecture where the baseband processing via the DU/CU combination supports a plurality of RUs with, for example, multiple DUs attaching to a single CU and/or multiple RUs attaching to single DU and/or other combinations. Base station elements, including the DUs and CUs can be collocated in a BS or AP 16 with multiple RUs—but they do not have to be collocated. In addition or in the alternative, the CU alone or the CUs and DUs can be implemented in network element 34-1. In this case, element 34-1 can include a combination of 1:N DUs and/or 1 or more CUs with, for example, a single DU aggregating multiple RUs and/or a single CU aggregating multiple DUs. Other configurations of RUs, DUs and CUs are likewise possible.

In various implementations, UEs can communicate with the RAN through either single or multiple links. Here, “link reliability” is referred to as the availability of redundant communication via (UE-RAN) paths. Link reliability can be affected by different factors such as lack of available radio resources, link blockages between the transmitter and receiver, low transmission quality and/or performance drops due to interference. Different approaches can be utilized to enhance link reliability. These include:
A bottom-up approach: Considering link failure probability from the context of radio frequency channel conditions for efficient RRM; and
A top-down approach: Providing redundancies assuring effectiveness of resource selections aimed at reliable communication.

Consider, for example, a shared-cell use case solution has been provided in O-RAN WG specifications (O-RAN.WG4.CUS, see e.g., https://specifications.o-ran.org/specifications). In a shared-cell model, multiple RUs operate as a single cell. Multiple RUs can transmit the same data stream over the reused portion of the bandwidth. Others have proposed solutions for UEs with hybrid switching between single serving cell and shared-cell and for dynamic grouping the RUs for a shared-cell that adds or removes a spectrum carrier to the group. However, the issue persists in decision making over use/re-use of resources in an uncoordinated way that can negatively influence the reliability of connections. In particular, a network might provide multiple links, but some of these links may not necessarily have a positive influence on the reliability assurance network-wide. Redundancies could be provided that fail to influence spectrum efficiency in each link. Although conflicts could be mitigated via higher level applications like conflict mitigation or through use of techniques such as beamforming. However, these are actions taken (possibly unnecessary or not optimal) following an inefficient approach of resource management. Therefore, earlier solutions failed to establish a top-down approach for a network with link reliability in a way that can be effectively integrated with a bottom-up finely detailed cooperative scheduling method.

Consider a RAN characterized by a RAN functionalities/modules such as RUs, DUs, CUs. Consider further a RAN-Set (or RANS) that represents a particular combination (e.g., a subset) of the available RAN functions/modules. In various examples, network element 34-1 includes a network general controller/scheduler 44 (or more simply a network general controller or “NGC”) that provides redundant data delivery to/from UEs by creating multiple links via combinations of necessary number of network functions determined as particular RANS and to the granularity of a determined RB-Set (RBS) via (UE-RBS-RANS) associations. This can result in the aggregation of multiple determined links (via the NGC) that increases the link reliability thanks to exploitation of combined macro (top-down) and micro level (bottom-up) diversity—as opposed to a one-dimensional diversity exploitation that relies on merely one or the other.

Various embodiments, examples and/or combinations improve on prior radio access networks by providing an effective and efficient network establishment and high level management of the communication via a NGC 44 that is configured to establish the network via a global selection and management of resources (including physical resources and/or spectrum). In various examples, the NGC configures the network based on expected services and entire available resources to:
create a necessary number of separate links in space to assure availability;
provide the redundancies of data transmission via effective selection of multiple links to assure a successful delivery; and
employ cooperative RRM for management of bandwidth (spectrum) allocation to provide reliable connection.
   Therefore, the efficient usage of the spectrum will be assured, while utilizing the effective selection of the transmission links.

In various examples, a network general controller, such as NGC 44 or other controller/scheduler, operates with a RAN such as RAN 45 or other RAN. The network general controller includes at least one processor and a memory configured to store operational instructions that, when executed by the at least one processor, cause the at least one processor to perform operations that include:
determining RAN conditions associated with the RAN, the RAN having a plurality of radio units (RUs), distributed units (DUs) and centralized units (CUs) that facilitate communication with user equipment (UEs) via a plurality of resource block sets (RBS);
determining a plurality of UE performance metrics corresponding to the UEs;
generating, based on the RAN conditions and based on the performance metrics corresponding to the UEs, selections of a plurality of RAN-Sets (RANS) from the plurality of RUs, DUs and CUs and a UE-RBS-RANS allocation that configures the communication with the UEs via redundant links based on the selections of the RANS and based on a multiplexed sequence of RBS of the plurality of RBS; and
facilitating, via at least one network interface, communication with the UEs in accordance with the UE-RBS-RANS allocation.

In addition or in the alternative to any of the foregoing, the UE performance metrics are determined by a session manager based on an expected quality of service.

In addition or in the alternative to any of the foregoing, the RAN conditions include one or more of: a bandwidth availability, load data, RU interference data, signal to noise and interference ratios, reference signal received powers, device positions, and/or workload predictions.

In addition or in the alternative to any of the foregoing, each of the plurality of RANS includes a proper subset of the plurality of RUs, DUs and CUs having an RU-Set, a DU-Set and a CU-Set.

In addition or in the alternative to any of the foregoing, two or more of plurality of RANS are intersecting subsets of the plurality of RUs, DUs and CUs.

In addition or in the alternative to any of the foregoing, the UE-RBS-RANS allocation is generated via a general scheduler that cooperatively associates each of the plurality of RANS with UEs based on spectrum level RBS allocation.

In addition or in the alternative to any of the foregoing, the general scheduler implements functionalities that are complementary to media access control (MAC) layer scheduling.

In addition or in the alternative to any of the foregoing, the general scheduler generates the UE-RBS-RANS allocation based on one or more of: UE quality of service, RB utilization, interference, throughput, energy efficiency, communication link reliability, security and/or cost efficiency.

In addition or in the alternative to any of the foregoing, the plurality of RANS facilitate the redundant links via multiple separate communication paths.

In addition or in the alternative to any of the foregoing, the redundant links convey redundant data via one or more of: Packet Data Convergence Protocol (PDCP) duplication, dual connectivity, copy and combine from an O-RAN shared-cell, Coordinated Multiple-Point (COMP) transmission, and/or MIMO transmission via distributedly deployed antennas (e.g., distributed MIMO).

In addition or in the alternative to any of the foregoing, a network general controller can be used in an exemplary architecture employing a general scheduler and cooperative RRM with one or more of the following considerations:
The network could include a single architecture or multiple architectures (e.g., cellular, cell-less coexisting, etc.);
RANS components (e.g., RUs/DUs/CUs) can be sourced from any vendor independently;
Deployment could be: centralized, distributed, with use of SMO, non-RT RIC or near-RT RIC, cascade or Fronthaul Multiplexer (FHM) mode of shared-cell from O-RAN specification and/or provide other deployments; and
Communication diversity can be implemented between receivers and transmitters by providing redundant data via any technique like PDCP duplication, dual connectivity, copy and combine from shared-cell or incorporating any MIMO transmission and/or other processing techniques.

Further details regarding the network general controller 44 and methods for use therewith, including several alternatives and optional functions and/or features, are presented in conjunction with the discussion that follows.

FIG. 1B is a flow diagram 100 illustrating a non-limiting example of a method in accordance with various aspects described herein. In particular, a method is presented for use in conjunction with, in addition or in alternative to any of the example architectures, examples, and/or embodiments described previously or in the sections that follow. Step 102 includes determining RAN conditions associated with the RAN, the RAN having a plurality of radio units (RUs), distributed units (DUs) and centralized units (CUs) that facilitate communication with user equipment (UEs) via a plurality of resource block sets (RBS). Step 104 includes determining a plurality of UE performance metrics corresponding to the UEs. Step 106 includes generating, based on the RAN conditions and based on the performance metrics corresponding to the UEs, selections of a plurality of RAN-Sets (RANS) from the plurality of RUs, DUs and CUs and a UE-RBS-RANS allocation that configures the communication with the UEs via redundant links based on the selections of the RANS and based on a multiplexed sequence of RBS of the plurality of RBS. Step 108 includes facilitating communication with the UEs in accordance with the UE-RBS-RANS allocation.

In addition or in the alternative to any of the foregoing, the UE performance metrics are determined by a session manager based on an expected quality of service.

In addition or in the alternative to any of the foregoing, the RAN conditions include one or more of: a bandwidth availability, load data, RU interference data, signal to noise and interference ratios, reference signal received powers, device positions, and/or workload predictions.

In addition or in the alternative to any of the foregoing, each of the plurality of RANS includes a proper subset of the plurality of RUs, DUs and CUs having an RU-set, a DU-Set and a CU-Set.

In addition or in the alternative to any of the foregoing, two or more of plurality of RANS are intersecting subsets of the plurality of RUs, DUs and CUs.

In addition or in the alternative to any of the foregoing, the UE-RBS-RANS allocation is generated via a general scheduler that cooperatively associates each of the plurality of RANS with UEs based on spectrum level RBS allocation.

In addition or in the alternative to any of the foregoing, the general scheduler implements functionalities that are complementary to media access control (MAC) layer scheduling.

In addition or in the alternative to any of the foregoing, the general scheduler generates the UE-RBS-RANS allocation based on one or more of: UE quality of service, RB utilization, interference, throughput, energy efficiency, communication link reliability, security and/or cost efficiency.

In addition or in the alternative to any of the foregoing, the plurality of RANS facilitate the redundant links via multiple separate communication paths.

In addition or in the alternative to any of the foregoing, the redundant links convey redundant data via one or more of: Packet Data Convergence Protocol (PDCP) duplication, dual connectivity, copy and combine from an O-RAN shared-cell, Coordinated Multiple-Point (COMP) transmission, and/or MIMO transmission.

In addition or in the alternative to any of the foregoing, a network general controller can be used in an exemplary architecture employing cooperative RRM with one or more of the considerations discussed above.

Consider the following further examples that can be used in conjunction with, in addition or in alternative to any of the example architectures, examples, and/or embodiments described.

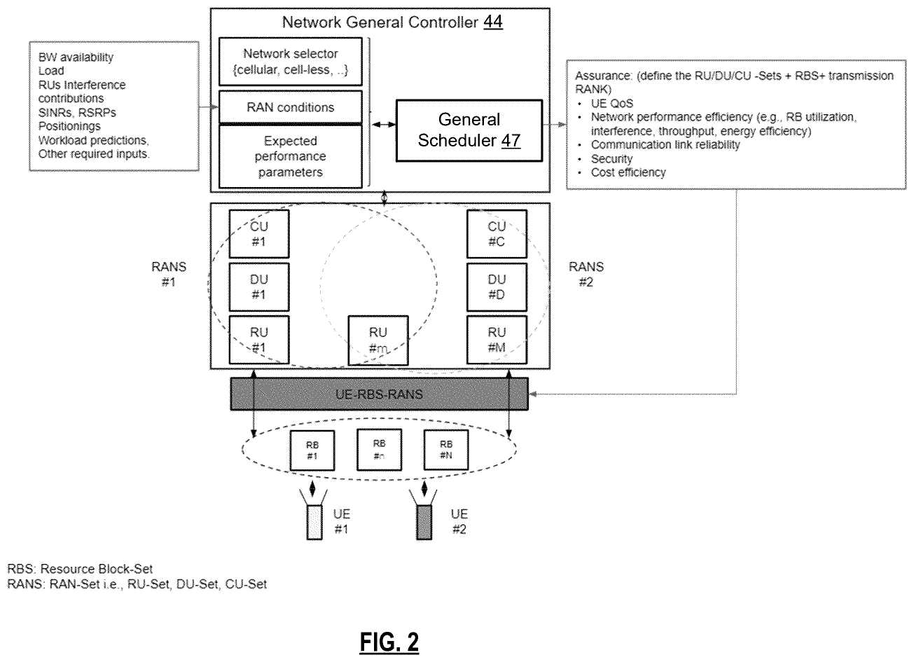

In FIG. 2, a Network General Controller 44 is shown as a conceptual frame that enables selection of appropriate RAN components creating a necessary number of separated links (e.g., redundant links) with the purpose of optimizing reliability of transmission. It establishes a network including two RAN-Sets (RANS) composed of components (for each RANS) that can be sources from one or multiple vendors/stakeholders/tenants. In the example shown, RANS #1 includes RU #1-RU #m, DU #1, and CU #1 and RANS #2 includes RU #m-RU #M, DU #D, and CU #C. While not explicitly shown, other RAN components (including other RUs, DUs and/or CUs) could likewise be allocated to these two RANS-on either a dedicated or shared basis.

The network architecture can be selected by the NGC 44 as cellular, cell-less, VRAN, cloud RAN, or other network architecture. The NGC 44 can include a general scheduler 47 (irrespective of the way of deployment, that could be with use of e.g., xAPP or central or distributed scheduler) that generates UE-RBS-RANS allocations to provide necessary redundancy of data transmission via multiple paths. In this regard, it determines, and considers RAN conditions. Accordingly, the general scheduler 47 provides RAN component selection and resource allocation to assure user service satisfaction and network efficiency. In various examples, the general scheduler can be implemented as a module of NGC 44, however, in other examples, the NGC 44 and general scheduler 47 can be implemented as separate modules in communication with one another.

In addition or in the alternative to any of the foregoing, the general scheduler 47 can operate by performing one or more of the following operations:
Select: particular selection of the network elements, providing a particular path/cluster/number of network functions/vendors/tenants from UE to core.
Mix: enable sharing/centralization/cooperation/coexistent/aggregation of network functions/modules with possible overlap (e.g., set intersection) among particular sets.
Match: Association of selected and mixed sets to users based on spectrum level RBS allocation corresponding to policies and objectives.

In various examples, RANS are established from one or more numbers of components including CU(s), DU(s), and RU(s). The general scheduler 47 associates each RANS with fine granularity at the spectrum level with UEs in a cooperative manner. The cooperativeness is applied for intra-RANS (among corresponding RUs) and inter-RANS.

In various examples, RANS operations of selecting, mixing and/or matching are aimed to ensure the effectiveness of enabling links-those components (e.g., RUs) that are meant to be incorporated for transmitting possibly redundant versions (i.e., copy) of data to/from) the corresponding end user UE—for successful reception (or transmission for uplink) of the data at UE (or from UE at uplink) through at least a link in case of outage of other link(s). The system applies exploration of macro diversity for improving reliability. In case there is no risk of link outage, the redundancies could be a means to respond to other needs such as capacity scaling rather than link reliability. Furthermore, the selection of UE-RBS-RANS, and the mixing and/or matching is in addition to scheduling of other resources (computing and physical resources, though it is not shown explicitly for simplicity).

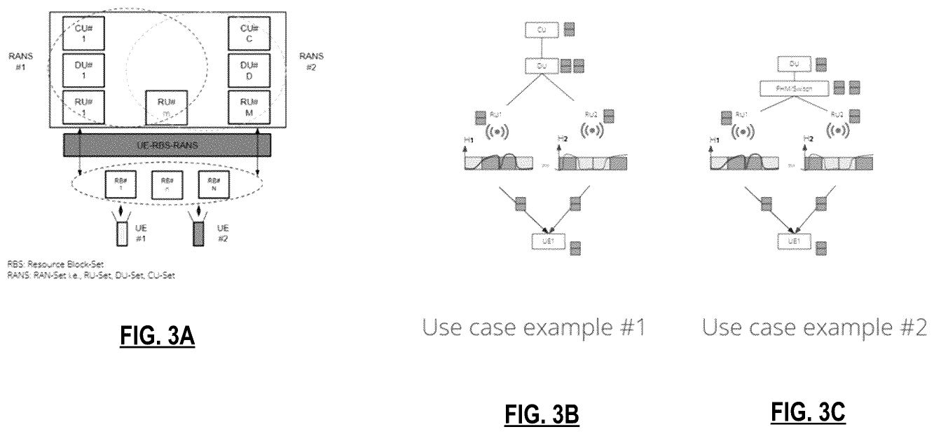

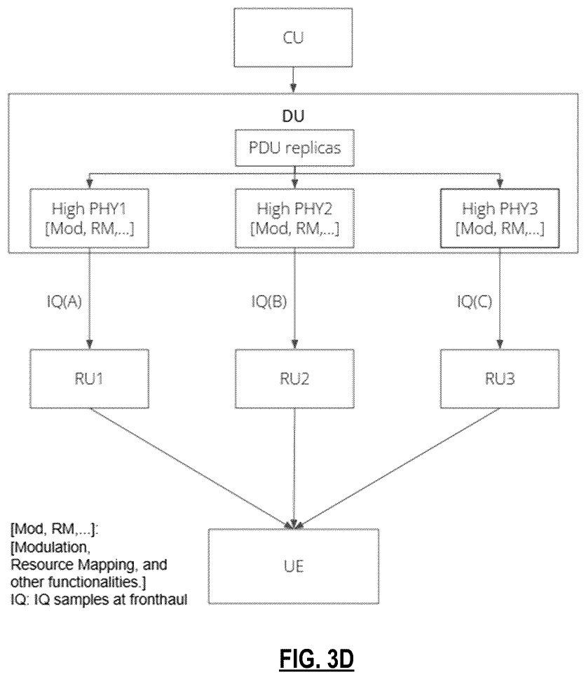

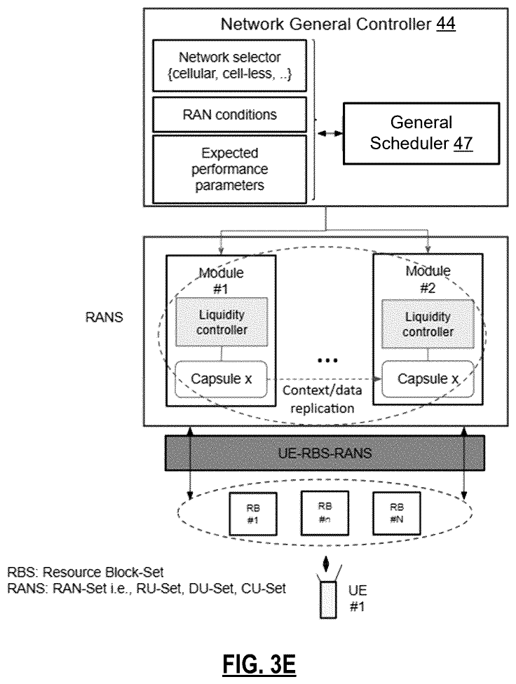

FIG. 3A presents an example that employs cooperative and fine granular scheduling of spectrum to enhance reliability via appropriate frequency diversity exploitation for varying channel conditions. The RANS are selected in similar fashion to FIG. 2. FIGS. 3B and 3C present two use cases and further present how RB spectrum allocations can be employed to provide redundant links to a particular UE. In particular, UE1 is provided with multiple copies of the signal transmitting from redundant spatially distributed links to combat instantaneous fading and/or other potential performance impacts. In these examples, the efficiency of transmission redundancy is backed up with cooperative and channel aware spectrum allocation.

FIG. 3D shows an example for the use case of FIG. 3B. where a DU unit processes the replicas of user data via multiple physical layer functions including modulation, resource mapping, and others for redundant transmissions through multiple RUs to a UE. In addition or in the alternative to any of the foregoing, FIG. 3E shows an example where user data can be replicated at multiple selected RAN modules/components and be processed within capsules that convey RAN functionalities. In this example of highly disaggregated RAN (e.g., U.S. application Ser. No. 19/095,690, filed on Mar. 31, 2025, entitled, “CAPSULE MIGRATION IN A FLEXIBLE SOFTWARE-DEFINED RADIO ACCESS NETWORK ARCHITECTURE AND METHODS FOR USE THEREWITH”, the contents of which are hereby incorporated by reference thereto for any and all purposes), the NGC can instruct the RAN modules via the liquidity controller for replication of capsule context including e.g. user data (or models, parameters of models etc.) into multiple selected modules. Other examples and uses cases are likewise possible.

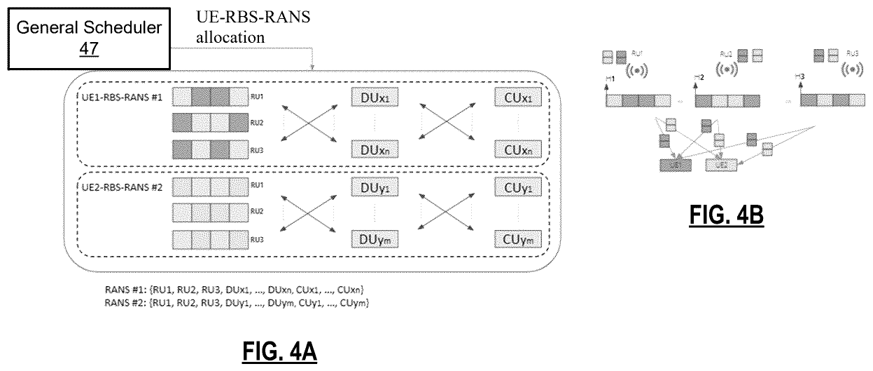

Turning now to FIG. 4A, a further example is presented where the general scheduler 47 allocates resources for each radio unit cooperatively to minimize the probability of link outage due to poor quality of inefficiently allocated spectrum. In the example shown, RANS #1 includes RU1-RU3, DUx1-DUxn, and CUx1-CUxn. RANS #2 includes RU1-RU3, DUy1-DUym, and CUy1-CUym. While not explicitly shown, other RAN components (including other RUs, DUs and/or CUs) could likewise be allocated to these two RANS-on either a dedicated or shared basis. Allocations are shown for UE1-RBS-RANS #1 and UE2-RBS-RANS #2. In particular, the RBS allocated to RANS #1 is shown via orange spectral blocks and the RBS allocated to RANS #2 is shown via yellow spectral blocks. In this fashion, redundant communication is enabled as shown in FIG. 4B.

In various examples, frequencies can be effectively and efficiently reused within each RANS. Consequently, the UEs are no longer obliged to be far from each other in space when they reuse the spectrum (possibly differently from RUs), thanks to the considered interference during scheduling. The scheduler allocates spectrum for each RU (from each particular RANS) cooperatively to the other RUs within the RANS and with other RANS. This enables performance stability in dense user conditions as well.

In various examples, cooperative scheduling exploits micro-diversity for efficient spectrum allocation to deliver the redundant copied data through multiple links (e.g., multiple RUs in space, or different antennas of the same RU distributed in space). Scheduling the bandwidth for the replicated packets could be employed through any deployment model like central scheduler, MAC scheduler at DU, distributed schedulers possibly with use of xApp/dApp, or any other deployment and implementation model.

In various examples, the general scheduler responsible for selecting, mixing and matching UE-RBS-RANS could be either provided with necessary measurements to make decisions for spectrum allocation (RB part) or it might take the RB allocations as input from a separate entity providing the network with cooperative spectrum allocations. Overall, RAN network functions are scheduled in a resource-efficient manner to provide end users with services through effectively reliable network connections.

While much of the foregoing has discussed allocation of RBs of RB-Sets corresponding to spectral portions such as spectral blocks, channels and/or other spectral resources—in addition or in the alternative to any of the foregoing, a network general controller could likewise allocate RBs that could be used in both systems of a time division duplex (TDD) scheme with UL/DL separation in the time domain and/or a frequency division duplex (FDD) scheme with UL/DL separation in the frequency domain and/or other time-based resources-either alone or in conjunction with frequency-based resources.

As may be used herein, the terms “substantially” and “approximately” provide an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. The processing module, module, processing circuit, processing circuitry, and/or processing unit can further include one or more interface devices for communicating data, signals and/or other information between the components of the processing module and further for communicating with other devices. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more examples have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more examples are used herein to illustrate one or more aspects, one or more features, one or more concepts, and/or one or more examples. A physical example of an apparatus, an article of manufacture, a machine, and/or of a process may include one or more of the aspects, features, concepts, examples, etc. described with reference to one or more of the examples discussed herein. Further, from figure to figure, the examples may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contrary, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the examples. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in the form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

One or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition—requires “artificial” intelligence—i.e. machine/non-human intelligence.

One or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

One or more functions associated with the methods and/or processes described herein can be implemented in a system that is operable to electronically store digital data in a memory device. Such storage cannot practically be performed by the human mind because the human mind is not equipped to electronically store digital data.

One or more functions associated with the methods and/or processes described herein may operate to cause an action by a processing module directly in response to a triggering event—without any intervening human interaction between the triggering event and the action. Any such actions may be identified as being performed “automatically”, “automatically based on” and/or “automatically in response to” such a triggering event. Furthermore, any such actions identified in such a fashion specifically preclude the operation of human activity with respect to these actions—even if the triggering event itself may be causally connected to a human activity of some kind.

While particular combinations of various functions and features of the one or more examples have been expressly described herein, other combinations of these features and functions are likewise possible. The present disclosure is not limited by the particular examples disclosed herein and expressly incorporates these other combinations.

What is claimed is:

1. A method for use with a radio access network (RAN), the method comprising:
determining RAN conditions associated with the RAN, the RAN having a plurality of radio units (RUs), distributed units (DUs) and centralized units (CUs) that facilitate communication with user equipment (UEs) via a plurality of resource block sets (RBS);
determining a plurality of UE performance metrics corresponding to the UEs;
generating, based on the RAN conditions and based on the performance metrics corresponding to the UEs, selections of a plurality of RAN-Sets (RANS) from the plurality of RUs, DUs and CUs and a UE-RBS-RANS allocation that configures the communication with the UEs via redundant links based on the selections of the RANS and based on a multiplexed sequence of RBS of the plurality of RBS; and
facilitating communication with the UEs in accordance with the UE-RBS-RANS allocation.

2. The method of claim 1, wherein the UE performance metrics are determined by a session manager based on an expected quality of service.

3. The method of claim 1, wherein the RAN conditions include one or more of: a bandwidth availability, load data, RU interference data, signal to noise and interference ratios, reference signal received powers, device positions, and/or workload predictions.

4. The method of claim 1, wherein each of the plurality of RANS includes a proper subset of the plurality of RUs, DUs and CUs having an RU-Set, a DU-Set and a CU-Set.

5. The method of claim 4, wherein two or more of plurality of RANS are intersecting subsets of the plurality of RUs, DUs and CUs.

6. The method of claim 1, wherein the UE-RBS-RANS allocation is generated via a general scheduler that cooperatively associates each of the plurality of RANS with UEs based on spectrum level RBS allocation.

7. The method of claim 6, wherein the general scheduler implements functionalities that are complementary to media access control (MAC) layer scheduling.

8. The method of claim 6, wherein the general scheduler generates the UE-RBS-RANS allocation based on one or more of: UE quality of service, RB utilization, interference, throughput, energy efficiency, communication link reliability, security and/or cost efficiency.

9. The method of claim 1, wherein the plurality of RANS facilitate the redundant links via multiple separate communication paths.

10. The method of claim 1, wherein the redundant links convey redundant data via one or more of: Packet Data Convergence Protocol (PDCP) duplication, dual connectivity, copy and combine from an O-RAN shared-cell, Coordinated Multiple-Point (COMP) transmission, and/or MIMO transmission.

11. A network general controller for use with a radio access network (RAN), the network general controller comprising:
at least one processor; and
a memory configured to store operational instructions that, when executed by the at least one processor, cause the at least one processor to perform operations that include:
determining RAN conditions associated with the RAN, the RAN having a plurality of radio units (RUs), distributed units (DUs) and centralized units (CUs) that facilitate communication with user equipment (UEs) via a plurality of resource block sets (RBS);
determining a plurality of UE performance metrics corresponding to the UEs;
generating, based on the RAN conditions and based on the performance metrics corresponding to the UEs, selections of a plurality of RAN-Sets (RANS) from the plurality of RUs, DUs and CUs and a UE-RBS-RANS allocation that configures the communication with the UEs via redundant links based on the selections of the RANS and based on a multiplexed sequence of RBS of the plurality of RBS; and
facilitating, via at least one network interface, communication with the UEs in accordance with the UE-RBS-RANS allocation.

12. The network general controller of claim 11, wherein the UE performance metrics are determined by a session manager based on an expected quality of service.

13. The network general controller of claim 11, wherein the RAN conditions include one or more of: a bandwidth availability, load data, RU interference data, signal to noise and interference ratios, reference signal received powers, device positions, and/or workload predictions.

14. The network general controller of claim 11, wherein each of the plurality of RANS includes a proper subset of the plurality of RUs, DUs and CUs having an RU-Set, a DU-Set and a CU-Set.

15. The network general controller of claim 14, wherein two or more of plurality of RANS are intersecting subsets of the plurality of RUs, DUs and CUs.

16. The network general controller of claim 11, wherein the UE-RBS-RANS allocation is generated via a general scheduler that cooperatively associates each of the plurality of RANS with UEs based on spectrum level RBS allocation.

17. The network general controller of claim 16, wherein the general scheduler implements functionalities that are complementary to media access control (MAC) layer scheduling.

18. The network general controller of claim 16, wherein the general scheduler generates the UE-RBS-RANS allocation based on one or more of: UE quality of service, RB utilization, interference, throughput, energy efficiency, communication link reliability, security and/or cost efficiency.

19. The network general controller of claim 11, wherein the plurality of RANS facilitate the redundant links via multiple separate communication paths.

20. The network general controller of claim 11, wherein the redundant links convey redundant data via one or more of: Packet Data Convergence Protocol (PDCP) duplication, dual connectivity, copy and combine from an O-RAN shared-cell, Coordinated Multiple-Point (COMP) transmission, and/or MIMO transmission.
